(19) United States
(12) Patent Application Publication
(10) Pub. No.: US 2023/0287923 A1
(43) Pub. Date: Sep. 14, 2023

(54) FASTENING ELEMENT AND ADJUSTMENT SYSTEM COMPRISING A FASTENING ELEMENT

(71) Applicant: KAMAX Holding GmbH & Co. KG, Homberg (Ohm) (DE)

(72) Inventor: Thorsten Schmitt, Laubach (DE)

(21) Appl. No.: 18/019,566

(22) PCT Filed: Jul. 15, 2021
(86) PCT No.: PCT/EP2021/069730

§ 371 Date: Feb. 3, 2023

(30) Foreign Application Priority Data
Aug. 6, 2020 (DE) 10 2020 120 806.5

(51) Int. Cl. F16B 35/04; F16B 35/06

(52) U.S. Cl. CPC F16B 35/041; F16B 35/06

(57) ABSTRACT

The invention relates to a fastening element, in particular an eccentric screw, and an adjustment system comprising a fastening element. Fastening elements are already known from the prior art. These are often used in an adjustment system in order, for example, to adjust chassis parts of a vehicle. For this, eccentric elements are often mounted or moulded on the fastening element in order to achieve adjustability in this way. To achieve secure positioning of the eccentric element on the fastening element, it is often guided on the fastening element in a rotationally fixed manner via a groove. The problem with this, however, is that the groove results in particularly expensive production of the fastening element, in particular owing to the shaping of the thread of the fastening element, since the shaping tool for shaping the thread is often damaged and/or severely worn by the groove, in particular the ramp thereof, and therefore these tools have only a short service life. It is therefore the object of the present invention to achieve cost-effective production of a fastening element, in particular for an adjustment system, in which the fastening element should at the same time have a high mechanical load-bearing capacity.

The invention relates to a fastening element, in particular an eccentric screw, and an adjustment system comprising a fastening element.

Fastening elements are already known from the prior art. These are often used in an adjustment system in order, for example, to adjust chassis parts of a vehicle. For this, eccentric elements are often mounted or molded on the fastening element in order to achieve adjustability. To achieve a secure positioning of the eccentric element on the fastening element, it is often guided rotationally fixedly on the fastening element via a groove. The problem here, however, is that the groove results in particularly expensive production of the fastening element, in particular owing to the shaping of the thread of the fastening element, since the shaping tool for forming the thread is often damaged and/or severely worn by the groove, in particular its runout slope, so that these tools have only a short service life.

It is therefore the object of the present invention to achieve a low-cost production of a fastening element, in particular for an adjustment system, wherein the fastening element should at the same time have a high mechanical load-bearing capacity.

This object is achieved with a fastening element according to claim 1, an adjustment system according to claim 14, and a production method for a fastening element according to claim 15. Advantageous refinements, features and embodiments arise from the dependent claims, the description and the figures.

According to one aspect of the invention, a fastening element is provided, in particular an eccentric fastening element and/or an eccentric screw, comprising a screw element, wherein the screw element extends in a longitudinal direction, wherein the screw element has a threaded portion, a head and a groove, wherein the groove extends in particular in the longitudinal direction, wherein the groove has a head end portion and a distal end portion, wherein the head end portion is arranged closer to the head in the longitudinal direction than the threaded portion, wherein the groove extends at least partially through the threaded portion. The fastening element according to the invention serves in particular for use in an adjustment system, advantageously for a vehicle or a chassis of a vehicle. The fastening element comprises at least one screw element which extends in the longitudinal direction. The longitudinal direction is here in particular the direction which determines the length of the screw element. Advantageously, the screw element is at least substantially rotationally symmetrical about this longitudinal direction. The term “substantially rotationally symmetrical” means in particular that over around 70% or more of the length, preferably at least 80% of the length of the screw element, the outer contour of the screw element is rotationally symmetrical about the longitudinal direction, wherein in this context in particular threads or knurling do not destroy a rotational symmetry. The screw element according to the invention comprises at least a threaded portion, a head and a groove. The head of the screw element advantageously forms a distal end portion in the longitudinal direction of the screw element. The head of the screw element here serves to ensure that via this, a torque can be transmitted to the screw element about the longitudinal direction, in particular by form fit. For this, the head in particular has tool contact faces to achieve mounting of the screw element and/or a general twist, e.g. for adjustment of a chassis. For example, the head of the screw element may therefore have tool contact faces in the form of an external hexagon and/or internal hexagon and/or a Torx fitting and/or a cross slot. The threaded portion of the screw element however, advantageously, also forms a distal end portion of the screw element in the longitudinal direction, wherein this end portion is preferably the distal end portion lying opposite the head in the longitudinal direction. The threaded portion comprises a thread, in particular on its outer periphery. This thread may for example be configured as a metric thread. Via the threaded portion, the screw element can easily be connected to further elements by force fit. As well as a threaded portion and a head, the screw element also comprises at least one groove. The groove of the screw element serves in particular to cooperate with a further element, in particular an eccentric element, such that a twist, in particular about the longitudinal direction, of the further element, in particular the eccentric element, relative to the screw element, is prevented by form fit. For example, this may be achieved in that a twist-prevention structure of the eccentric element engages in the groove of the screw element so that a twist of the eccentric element about the longitudinal direction relative to the screw element is prevented by form fit. Thus in a particularly simple fashion, an adjustment of the further element, in particular the eccentric element, can be achieved by a twist of the fastening element. The groove of the screw element in particular extends linearly and/or in or parallel to the longitudinal direction. Thus a particularly simple production of the groove can be achieved. The groove of the screw element here has a head end portion and a distal end portion. The respective end portion is the portion at which the groove has a free runout end and/or a closed end. A closed end is the region of the groove at which the laterally delimiting contours of the groove join or meet, and hence the course of the groove in its extent is terminated by the join. A free runout end, in contrast, is an end at which the laterally delimiting contours do not join, but rather for example an edge or shoulder terminates the groove course. Alternatively or additionally, preferably, the respective end portion may already be present in the regions in which the groove, in particular the base portion of the groove, has an increasing distance from the longitudinal direction or longitudinal axis. In other words, this may mean that the end portion of a groove may also be formed by the region in which the groove has a diminishing groove depth along its course. The groove of the screw element according to the invention is here configured such that it extends at least partially through the threaded portion. In other words, this may mean that at least a part of the groove runs in the threaded portion, so that a sectional plane through the threaded portion—with a normal parallel to the longitudinal direction—also intersects the groove. The head end portion of the groove of the screw element is arranged such that, viewed in the longitudinal direction, it is at least partially arranged closer to the head than the threaded portion. In other words, this may mean that the head end portion has a smaller distance from the head in the longitudinal direction than the threaded portion. The threaded portion of the screw element decisive for this assessment is the threaded portion through which the at least one groove of the screw element extends. Advantageously, the screw element according to the invention comprises not only one such groove, but rather several such grooves may be provided, wherein these may each have some or all features of the described groove. Advantageously, the grooves are distributed or arranged equidistantly about the circumference of the screw element. By forming the head end portion in a region which is arranged closer to the head than the threaded portion, it may be achieved that the head end portion of the groove is at least partially, preferably completely thread-free. Thus, in particular on rolling of the thread, a significantly longer service life of the tooling may be achieved, leading to economic production of the fastening element. In addition, in this way, also the stress concentrations of the head end portion may be reduced, leading at the same time to a high mechanical load-bearing capacity of the screw.

Advantageously, the groove extends completely through the threaded portion. Extending completely through the threaded portion means that there is no section plane through the threaded portion, having a normal parallel to the longitudinal direction, which does not also intersect the groove. In addition however, the groove may also extend over further regions of the screw element so that the groove may also extend beyond the threaded portion. This design of the groove may allow particularly simple mounting of an eccentric element inside the groove.

Preferably, in a section plane with a normal parallel to the longitudinal direction, the groove has a rounded base and/or rounded side portions, wherein the base and/or side portion in particular has an advantageously constant rounding radius. The base portion of the groove is the groove portion facing the longitudinal direction. In other words, the base portion delimits the groove in the direction towards the longitudinal direction. The side portions of the groove are the groove parts which form a lateral contour on the surface(s) in which the groove is made. The side portions therefore delimit the groove laterally relative to the course of the groove. Advantageously, a ratio of the rounding radius of the base and/or side portion of the groove to the diameter of the threaded portion lies in a range of 0.1 to 0.5, preferably in a range of 0.2 to 0.3. With a ratio in the range of 0.1 to 0.5, a screw element with a particularly high mechanical load-bearing capacity can be achieved. With a ratio in the range of 0.2 to 0.3, the applicant has surprisingly found that this may achieve a particularly long service life of the tooling, in particular the shaping tool, for forming the groove and/or threaded portion. To achieve economic production, it is particularly suitable if the rounding radii of the base and/or side portions are the same.

Suitably, the screw element is produced by a shaping process, and/or the groove is produced by means of a shaping process, in particular embossed and/or rolled, and/or with a material removal process. By producing these screw element in a shaping process, a structure with a particularly high mechanical load-bearing capacity inside the screw element can be achieved, so that the screw also a high mechanical strength. If the groove is produced by embossing or rolling or another shaping process, an advantageous “chamfer course” in the screw element may also be achieved, so that the strength of the screw element may also be increased and/or at least positively influenced thereby. If the groove is produced using a material removal process, a particularly high geometric precision may be achieved, so that in this way a form-fit twist prevention with particularly high mechanical strength can be achieved with an eccentric element. A material removal process may for example be a grinding process, a milling process, shaving or planning.

Suitably, the screw element has a carrier region, wherein the carrier region is in particular arranged closer to the head in the longitudinal direction than the head end portion of the groove and/or than the threaded portion. The carrier region of the screw element during production serves to set the screw element in rotation on rolling of the thread, in particular by means of roller jaws. In other words, the carrier region of the screw element serves to ensure adequate rotation of the screw element blank or screw element during the production process of the thread. The carrier region is in particular arranged such that, viewed in the longitudinal direction, this is arranged closer to the head than the head end portion of the groove and/or than the threaded portion. This may achieve that the carrier region can be formed without a groove. Forming without a groove means that the groove does not extend into the carrier region. The “groove-free” carrier region may allow a particularly simple production of the carrier region, and/or a carrier region with particularly high mechanical load-bearing capacity. By forming the carrier region closer to the head in the longitudinal direction than the head end portion of the groove and/or the threaded portion, it may also be achieved that, on rolling of the thread, there is always sufficient contact area for the roller jaws in the carrier region. Therefore in this way, particularly effectively, a high and/or secure torque transmission between the roller jaws and carrier region can be achieved. Advantageously, the carrier region is delimited by shoulders and/or ring grooves in the positive and/or negative longitudinal direction. In other words, viewed in the longitudinal direction, the distal ends of the carrier region may be arranged closest to the shoulders or ring grooves. Thus a clear delimitation from other regions of the screw element may be achieved, so that it can be ensured that these regions are used in any case at least slightly for torque transmission during production of the screw element and/or the fastening element.

Advantageously, the carrier region is configured so that this is rotationally symmetrical about the longitudinal direction, in particular cylindrical. In this way, a particularly simple and low-cost design of the carrier region can be achieved.

Advantageously, the head end portion of the groove lies at least partially, preferably completely, between the threaded portion and the head and/or has at least a minimum distance from the head and/or from the threaded portion in the longitudinal direction. The minimum distance is here preferably 0.5 mm, 1 mm or 1.5 mm. Alternatively or additionally, preferably the minimum distance may also be 0.1 times the outer diameter of the threaded portion. Arranging the groove runout at a distance from the threaded portion and from the head in the longitudinal direction may achieve a particularly good distribution of the stress concentrations in the longitudinal direction.

In an advantageous refinement, the head end portion of the groove lies at least partially, preferably completely between the threaded portion and the carrier region in the longitudinal direction. The decisive portion here is in particular the portion of the head end portion in which the groove forms its final distal end, viewed in the longitudinal direction. Alternatively or additionally, preferably, the decisive portion may be the part of the head end portion of the groove in which the groove, viewed along its course in the longitudinal direction, begins to have an increasing distance from the longitudinal direction. In other words, alternatively and preferably, the end portion of the groove in which this begins to lose its original and/or minimum distance from the longitudinal direction may be decisive. By forming the end portion between the threaded portion and the carrier region in the longitudinal direction, in simple fashion a groove runout with particularly low stress concentration can be achieved. In addition, thus a weakening of the carrier region may also be prevented or reduced.

Advantageously, the carrier region has the same core and/or outer diameter as the threaded portion. In other words, the core and/or outer diameter of the threaded portion may correspond to the respective core and/or outer diameter of the carrier region. The core diameter is in particular twice the smallest possible distance of the decisive outer circumferential region from the longitudinal direction. The outer diameter of the carrier region or threaded portion however is in particular twice the distance of the furthest outer region of the carrier region and/or threaded portion from the longitudinal direction. The definition of the core and/or outer diameter are here, in particular in a thread, known as the core diameter and outer diameter. Alternatively or additionally, preferably, the flank diameter of the carrier region may also be the same as the flank diameter of the threaded portion.

In a preferred embodiment, the carrier region has carrier structures on its outer periphery, wherein the carrier structures allow a form-fit torque transmission about the longitudinal direction. The carrier structures may be structures which are produced in the carrier region during and/or before the thread rolling process. These carrier structures therefore serve to transmit, by form fit, a torque about the longitudinal direction from the roller jaws to the fastening element and/or the screw element. In this way, a particularly secure torque transmission can be achieved, so that a particularly secure and low-cost production of the thread is possible by means of a shaping process, in particular a rolling process. For example, it is thereby possible to achieve a screw strength class of the screw element of >10.9, in particular at least 12.9.

Suitably, the carrier structure comprises a wedge toothing and/or a thread. Alternatively or additionally, the carrier structure may also be a knurling and/or a multitoothed structure. This/these carrier structure(s) may achieve a particularly safe and simple torque transmission during the shaping process of the threaded portion.

Advantageously, the carrier structure, when formed as a thread, is arranged and/or formed such that the thread turns of the thread in the carrier structure form a direct extension of the thread or thread turns of the threaded portion of the screw element. In other words, the thread turn(s) of the carrier structure may be arranged such that, viewed in the rotational direction about the longitudinal axis, these have no rotational offset from the theoretical continuation of the thread turns of the threaded portion of the screw element. Thus the carrier region may also be used for fixing so that in this way, in a simple and low-cost fashion, a further possibility for fixing to the screw element can be achieved or provided.

Suitably, the screw element has a strength class of ≥10.9. By forming the screw element to have a strength class above 10.9, it can be achieved that the screw element can also be used in high-strength screw connections. Advantageously therefore, the material of the screw element has a tensile strength Rₘ in N/mm² of more than 1000, and/or an elongation at break A in % of 9. The decisive factor for the higher strength class here is the tensile strength of the material used for the screw element. For assessment of the tensile strength, in particular the material which is used in the threaded portion, the head and/or the groove region is decisive.

Advantageously, the head end portion of the groove, in particular viewed in the longitudinal direction, is arranged in a ring groove running around the longitudinal direction. Thus a particularly low stress concentration by the end portion can be achieved, so that in particular the bending strength of the screw is only slightly negatively affected by the stress concentration of the groove end portion. In addition, a high level of elasticity can thereby also be achieved, so that the screw element or fastening element has a high fatigue strength.

Suitably, the fastening element has an eccentric structure, wherein the eccentric structure is rotationally fixed about the longitudinal direction relative to the screw element. The eccentric structure in particular has an outer circumferential structure and/or contour which is eccentric and/or cam-shaped relative to the longitudinal direction. The eccentric structure in mounted or fixed state is arranged so as to be rotationally fixed about the longitudinal direction relative to the screw element. In other words, a torque about the longitudinal direction can be transmitted, in particular by form fit, between the eccentric structure and the screw element. Thus because of the eccentric or cam-like structure of the eccentric structure, the fastening element may be used to adjust for example a chassis element of a vehicle.

Advantageously, the eccentric structure is formed integrally with the screw element, or alternatively and preferably, the eccentric structure may also be a separate component from the screw element. If the eccentric structure is formed integrally with the screw element, in a particularly simple fashion, the eccentric structure can be connected to the fastening element or screw element with a high mechanical load-bearing capacity. Particularly preferably, the eccentric structure and screw element are produced from the same or a single blank by a forming and/or shaping process. Therefore the eccentric element is preferably not joined to the screw element by substance bonding. In other words, it may therefore be preferred that the fastening element is formed integrally in order to achieve a particularly high mechanical load-bearing capacity. In order however to save production costs, it may be advantageous for the eccentric structure to be formed as a separate component. Here it is preferred if the torque about the longitudinal direction is transmitted between the eccentric structure and screw element by form fit in a mounted state. Advantageously, the eccentric structure may, alternatively or additionally, preferably also be shrink-fitted, pressed and/or caulked onto a region of the screw element, in order to secure the eccentric structure captively in the longitudinal direction of the screw element.

In a preferred embodiment, the eccentric structure is arranged closer to the head in the longitudinal direction than the head end portion of the groove and/or than the carrier region and/or the threaded portion, wherein the eccentric structure is advantageously arranged directly adjacent to the head in the longitudinal direction. By arranging the eccentric structure particularly close to the head in the longitudinal direction, it is achieved that only a slight relative twist about the longitudinal direction takes place between the head and the eccentric element on actuation, so that a particularly high adjustment accuracy can thereby be achieved. In addition or alternatively, preferably, by the provision of the eccentric structure closer to the head in the longitudinal direction than the head end portion of the groove and/or the carrier region and/or the threaded portion, it may also be achieved that these regions are not loaded by any applied or actuating torque which is introduced to the head of the screw element. Therefore, by the above-described arrangement of the eccentric structure in the longitudinal direction, a screw element with particularly high mechanical load-bearing capacity can be achieved.

A further aspect of the invention may concern an adjustment system comprising a fastening element as described above and below, and an eccentric element, wherein the eccentric element has a twist-prevention structure, wherein the twist-prevention structure engages in the groove such that a rotation of the eccentric element about the longitudinal direction relative to the screw element is prevented by form fit. In particular on its outer periphery, the eccentric element has an eccentric and/or cam-like structure, and advantageously on its inner periphery a twist-prevention structure which, in mounted state, engages in the groove so that a twist of the eccentric element relative to the screw element of the fastening element is prevented by form fit. The outer eccentric structure of the eccentric element is here in particular formed eccentric to the longitudinal direction. By the provision of an eccentric element, in a simple fashion, additionally or alternatively to the eccentric structure, an adjustment facility is created for the adjustment system, for example for a chassis part of a vehicle. The adjustment system therefore in particular serves for use for example in a vehicle. For example, via such an adjustment system, a control arm in a chassis and/or a wheel suspension of a vehicle may be adjusted.

Advantageously, the eccentric element and eccentric structure are similarly eccentric, wherein in particular the projection of the outer contour of the eccentric element and the outer contour of the eccentric structure are congruent in the longitudinal direction. The decisive factor for assessing congruence and similarity is in particular the mounted state of the eccentric structure and eccentric element relative to the screw element. The mounted state generally is, in particular, the state in which all elements of the fastening element and/or adjustment system have assumed their definitive position relative to one another, in particular in the longitudinal direction. Therefore, in particular, the twist-prevention structure of the eccentric element in mounted state engages at least in the one groove of the screw element. The term “similarly eccentric” here means that the eccentricities of both the eccentric element and also the eccentric structure relative to the longitudinal direction have a similar form and similar direction. This similarity of form may be achieved in that, on twisting of the screw element or fastening element, a similarly formed and simultaneous adjustment can be achieved by the eccentric element and the eccentric structure.

A further aspect of the invention may concern a method for producing a fastening element in particular as described above and below. Such a production method may comprise the steps:
provision of a blank;
forming of a threaded portion by shaping, in particular by rolling;
in particular, shaping of the blank so as to produce a head;
shaping of the blank and/or machining of the blank with a material removal process, in particular milling, so as to produce a groove, wherein the groove has a head end portion and a distal end portion, wherein the head end portion is arranged closer to the head in the longitudinal direction than the threaded portion, wherein the groove extends at least partially through the threaded portion.

With this production process, the advantages already presented for the fastening element can be achieved in simple fashion. In particular, during rolling of the threaded portion, a three-piece rolling tool may be used, wherein one part of the rolling tool shapes the threaded portion, advantageously a further part of the rolling tool makes a ring groove in the screw element and/or performs no shaping of the screw element, and a third part may in particular produce the carrier region of the screw element by shaping and/or a torque may be transmitted between the rolling tool and carrier region, in particular by form fit and/or alternatively preferably by friction fit. A further aspect of the invention may therefore also concerns a rolling tool, in particular a roller jaw, or a rolling tool set.

In a preferred embodiment, the method for production comprises the further steps: forming and/or shaping a carrier region with at least one carrier structure, wherein the carrier structure(s) is/are formed in particular in the same process step, in particular by rolling, in that the threaded portion is also formed by rolling. Thus a particularly low cost and mechanically high-strength fastening element can be achieved.

Further advantages and features of the present invention arise from the following description with reference to the figures. Individual features of the embodiment shown may also be used in other embodiments unless this is expressly excluded. In the drawings:

FIG. 1 shows a view with a partial section of an adjustment system;

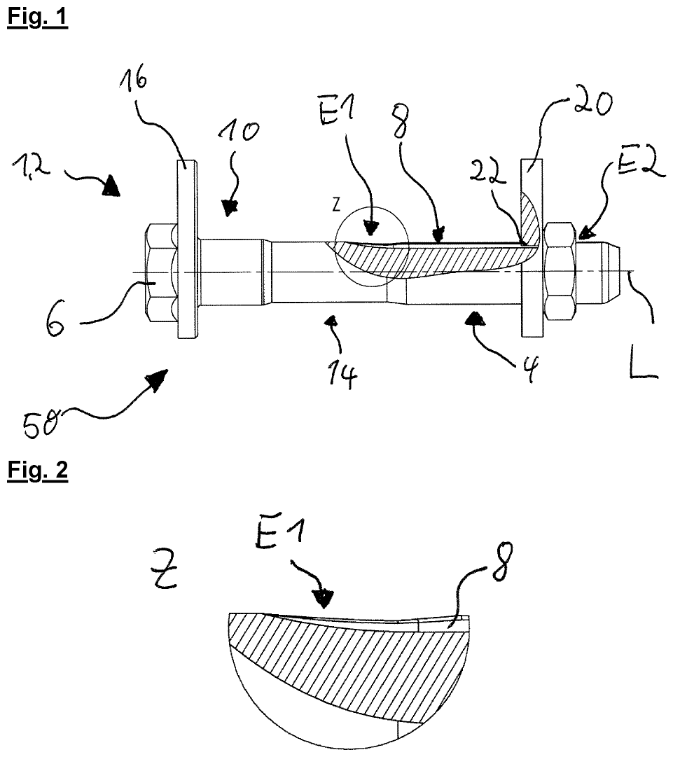

FIG. 2 shows a partial view in the region of the head end portion of the groove of the screw element; and

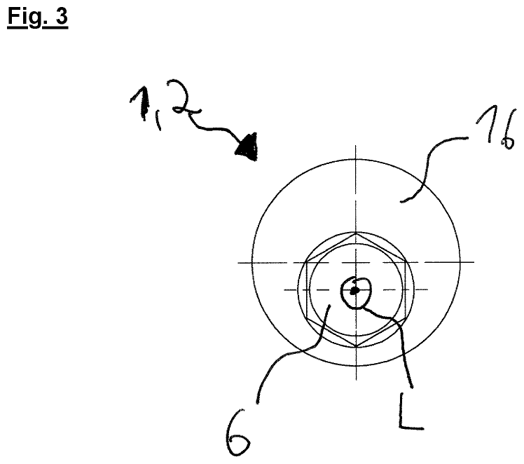

FIG. 3 shows a view of a screw element in the longitudinal direction.

FIG. 1 shows an adjustment system 50 comprising a fastening element 1 and an eccentric element 20. The fastening element 1 comprises a screw element 2 which is formed integrally with an eccentric structure 16. Therefore the fastening element 1 is formed integrally in FIG. 1. In the longitudinal direction L, a distal end region of the screw element 2 is formed by the head 6. The head 6 is configured as an external hexagon. The eccentric structure 16 of the fastening element 1 is here arranged directly adjacent to the head in the longitudinal direction L. The carrier region 10 is arranged next to the eccentric structure 16 in the longitudinal direction L. A wide ring groove 14 is arranged between the carrier region 10 and the threaded portion 4 of the screw element 2. The eccentric element 20 is arranged partially surrounding the threaded portion 4 of the screw element 2, wherein the eccentric element 20 has a twist-prevention structure 22 which engages in the groove 8 of the screw element 2. The groove 8 here has a distal end portion E2 in the longitudinal direction L and a head end portion E1 in the longitudinal direction. The head end portion E1 is situated in the ring groove 14. The distal end portion E2 of the groove 8 however runs out below the mounted nut and is not therefore evident in FIG. 1. In FIG. 1, Z indicates a detail view which is shown in more detail in FIG. 2.

FIG. 2 shows the detail view marked Z in FIG. 1 in more detail. FIG. 2 therefore shows the head end portion E1 of the groove 8 which is arranged in particular mostly and/or (as shown in FIG. 2) completely inside the ring groove 14.

FIG. 3 shows a view of a screw element 2 of a fastening element 1 in the longitudinal direction L. In FIG. 3, the eccentric structure 16 of the fastening element 1 can be seen. Because the outer contour of an eccentric element 20 may be congruent with the eccentric structure 16 in the longitudinal direction L, the outer contour of the eccentric structure 16 may also correspond to the outer contour of an eccentric element 20 which is not otherwise visible in FIG. 3.

### LIST OF REFERENCE SIGNS

1—Fastening element
2—Screw element
4—Threaded portion
6—Head
8—Groove
10—Carrier region
14—Ring groove
16—Eccentric structure
20—Eccentric element
22—Twist-prevention structure
50—Adjustment system
E1—Head end portion of groove (8)
E2—Distal end portion of groove (8)
L—Longitudinal direction or longitudinal axis

1. A fastening element (1) comprising a screw element (2),
wherein the screw element (2) extends in a longitudinal direction (L),
wherein the screw element (2) has a threaded portion (4), a head (6) and a groove (8),
wherein the groove (8) extends in particular in the longitudinal direction (L),
wherein the groove (8) has a head end portion (E1) and a distal end portion (E2),
wherein the head end portion (E1) is arranged closer to the head (6) in the longitudinal direction (L) than the threaded portion (4),
wherein the groove (8) extends at least partially through the threaded portion (4),
wherein the screw element (2) has a strength class of more than 10.9 or equal to 10.9,
wherein the groove (8) has a rounded base and/or rounded side portions in a sectional plane with a normal parallel to the longitudinal direction (L),
wherein a ratio of the rounding radius of the base and/or side portion of the groove (8) to the diameter of the threaded portion (4) lies in a range of 0.1 to 0.5, preferably in a range of 0.2 to 0.3,
wherein the groove (8) is embossed and/or rolled, or
wherein the screw element (2) is produced by a shaping process.

2. The fastening element (1) as claimed in claim 1,
wherein the groove (8) extends completely through the threaded portion (4).

3. The fastening element (1) as claimed in claim 1,
wherein the screw element (2) has a carrier region (10),
wherein the carrier region (10) is arranged closer to the head (6) in the longitudinal direction (L) than the head end portion (E1) of the groove (8) and/or than the threaded portion (4).

4. The fastening element (1) as claimed in claim 1,
wherein the head end portion (E1) of the groove (8) lies between the threaded portion (4) and the carrier region (10) in the longitudinal direction (L).

5. The fastening element (1) as claimed in claim 1,
wherein the carrier region (10) has the same core and/or outer diameter as the threaded portion (4).

6. The fastening element (1) as claimed in claim 1,
wherein the carrier region (10) has carrier structures on its outer periphery,
wherein the carrier structures allow a form-fit torque transmission about the longitudinal direction (L).

7. The fastening element (1) as claimed in claim 1,
wherein the carrier structures comprise a wedge toothing and/or a thread.

8. The fastening element (1) as claimed in claim 1
wherein the head end portion (E1) of the groove (8), in particular viewed in the longitudinal direction (L), is arranged in a ring groove (14) running around the longitudinal direction (L).

9. The fastening element (1) as claimed in claim 1,
wherein the fastening element (1) has an eccentric structure (16),
wherein the eccentric structure (16) is rotationally fixed about the longitudinal direction (L) relative to the screw element (2).

10. The fastening element (1) as claimed in claim 1,
wherein the eccentric structure (16) is formed integrally with the screw element (2), or
wherein the eccentric structure (16) is a separate component.

11. The fastening element (1) as claimed in claim 1,
wherein the eccentric structure (16) is arranged closer to the head (6) in the longitudinal direction (L) than the head end portion (E1) of the groove (8) and/or than the carrier region (10) and/or the threaded portion (4),
wherein the eccentric structure (16) is advantageously arranged directly adjacent to the head (6) in the longitudinal direction (L).

12. An adjustment system (50) comprising a fastening element (1) as claimed in claim 1 and an eccentric element (20),
wherein the eccentric element (20) has a twist-prevention structure (22),
wherein the twist-prevention structure (22) engages in the groove (8) such that a rotation of the eccentric element (20) about the longitudinal direction (L) relative to the screw element (2) is prevented by form fit.

13. A method for producing a fastening element (1) as claimed in claim 1, comprising the steps:
provision of a blank;
rolling of a threaded portion (4);
in particular, shaping of the blank so as to produce a head (6);
shaping of the blank and/or machining of the blank with a material removal process, in particular milling, so as to produce a groove (8),
wherein the groove (8) has a head end portion (E1) and a distal end portion (E2),
wherein the head end portion (E1) is arranged closer to the head (6) in the longitudinal direction (L) than the threaded portion (4),
wherein the groove (8) extends at least partially through the threaded portion (4).
